(19) United States
(12) Patent Application Publication
(10) Pub. No.: US 2005/0005077 A1
(43) Pub. Date: Jan. 6, 2005

(54) Method, data processing device, and loading device for loading data into a memory with complete memory occupancy

(76) Inventor: Clemens Heinrich, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 10/856,366

(22) Filed: May 28, 2004

(30) Foreign Application Priority Data
May 28, 2003 (DE) 103 24 507.3-53

(51) Int. Cl. G06F 12/00

(52) U.S. Cl. 711/154

(57) ABSTRACT

In a method for loading data into a memory device of a data processing device, the memory device being connected to a processing unit, the first processing unit, by accessing a loader program stored in said memory device, in a loading step, loads the data into the memory device and, for achieving complete memory occupancy, in the loading step the available memory capacity of the memory device is completely occupied.

### BACKGROUND OF THE INVENTION

I. Field of the Invention

The present invention relates to a method for loading data into a first memory device of a data processing device, the device being connected to a first processing unit, and the first processing unit, by accessing a loader program stored in the memory device, in a loading step, loading first data into the first memory device. The invention further relates to a data processing device which is suitable for implementing the method, as well as a loading device which is suitable for implementing the method.

II. Description of the Prior Art

In a multitude of applications of data processing devices it is desirable or necessary for the data processing device to be operated exclusively with authorized application programs. This allows the data processing device to make available only the functions which are required for its intended use. In particular in the case of data processing devices which are used to carry out security-relevant procedures, any attempts at manipulation or misuse can be counteracted in this way. Security modules of franking machines, with which accounting-relevant operations are carried out, are one example of such data processing devices.

In order to ensure that only authorized application programs are used in such data processing devices, the use of cryptographic means is known, making it possible to verify the authenticity of the loaded program. European Application 0 847 031, among other things, discloses the generation of a digital signature over the program to be loaded, the digital signature then being checked in the data processing device using a corresponding verification key.

This ensures that only authorized data is loaded in such a loading process with the use of the loader program. A problem associated with this known approach is that non-authorized data which has entered into the memory device in some other way, in particular by bypassing the loader program, are not detected. If such data relates to an unauthorized application program or data leading to an unauthorized function of an authorized application program, there is the danger that the data processing device may carry out unauthorized functions without this being detected.

The approach explained above has a further disadvantage, which is that it is relatively expensive because it requires the incorporation of a verification key and a corresponding verification algorithm in each data processing device.

### SUMMARY OF THE INVENTION

An object of the present invention is to provide a method and a data processing device of the general type described initially, which do not have, or at least alleviate, the above-mentioned disadvantages, and which in particular ensure in a simple way that only authorized data are present in the memory device.

This object is achieved by a method, a data processing device and a loading device wherein it is ensured in a simple way that authorized data are exclusively present in the memory device by, for the purpose of achieving complete memory coverage, completely occupying the available memory capacity of the memory device in the loading step. Complete occupation of the available memory capacity thus ensures in an easy way that no memory capacity is available for further, unauthorized data, and that any unauthorized data which may already be present are overwritten during loading.

In the simplest case the data and the memory capacity of the memory device can be matched to each other such that the data, when loaded into the memory device, apart from the memory capacity for the loader program, exactly fill the available memory capacity of the memory device when the data are stored in the memory device. Preferably, however, those memory areas of the memory device, which in the loading step have not been occupied by the loader program or the data, are filled with padding data. This avoids in a simple way the need for precise matching between the data and the capacity of the memory device, so that there is greater freedom of design in regard to dimensioning the data or the memory device.

The padding data may be data which have been provided in any desired way, the padding data completely filling the memory capacity which is still available apart from the loader program and the data. Preferably, the padding data are composed of one or several random numbers. This prevents the possibility of manipulating the filled-in region by exploiting constantly recurring data patterns occurring during the filling event. It is thus possible to prevent, for example, a situation where in such a regular data pattern, an unauthorized executable program is hidden and undetected.

The padding data may be generated by a suitable algorithm that, for example, can be integrated in the loader program. The padding data may be placed, during or after the process of writing the usable data to the memory device, in the first memory device in the corresponding areas which remain free. Preferably, the padding data are provided by a loading device which is connected to the processing unit. In this way it is possible to prevent manipulation, by an unauthorized program that is already present in the memory device, of the process of generating the padding data in an attempt to prevent overwriting the unauthorized program.

Generally, such a loading device is connected to the processing unit by a suitable interface. Usually, the usable data also are made available by the loading device.

In an embodiment of the method according to the invention, the available memory capacity of the memory device, in at least one checking step, is divided into at least two memory segments, and a checksum is formed over the contents of each of the memory segments, with the checksum being compared with an associated comparison checksum. This checking step ensures that no undetected manipulation of the data was carried out during loading of the first data.

In a further embodiment, division of the memory capacity into partly overlapping memory segments takes place. This ensures in a simple and effective way that gaps between memory segments are prevented, in which gaps unauthorized data might otherwise find the necessary space.

If at least one of the checksums is not in a particular specific relation to the associated comparison checksum—in other words, if for example one of the checksums does not correspond to its associated comparison checksum—then this may be signaled in a suitable way. The user will then immediately know that loading of the data did not occur in the proper way and can draw the corresponding conclusions from this. Likewise, in such a case the processing unit or other components of the data processing device can be blocked to prevent further operation.

It should be noted that, in the context of the present application, the term “memory device” not only refers to a single memory module with a single, joined or connected memory areas, but also, such a memory device may have several separate memory modules which, if needed, may be based on various memory formats or types.

If the memory device has several separate memory areas, in the checking step each memory area preferably is divided into at least two memory sub-segment. After this, analogously to the explanations above, for each memory sub-segment a corresponding checksum is generated and compared to an associated comparison checksum.

Dividing the available memory capacity into memory segments can take place according to any specified scheme. Preferably, the division into memory segments is determined for each checking step according to a variable algorithm. This makes manipulation of the checksums more difficult. Preferably, division into memory segments is determined according to the random principle, since in this way particularly good security against manipulation can be achieved. In this process, both the size and the position of the corresponding memory segment may be determined according to the random principle. In this process, any desired suitable random algorithms or pseudo-random algorithms may be used.

Formation of the checksums may take place in any known way with the use of corresponding algorithms. In embodiments of the method according to the invention the checksum is formed cryptographically. Any known cryptographic checksum algorithms such as, for example, SHA-1, MD4, MD5 etc. may be used. These checksum algorithms are not necessarily based on the use of keys, but it is understood that for generating the checksums it is possible also to use key-based algorithms, in particular any known encryption algorithms.

The checking step may take place exclusively in the data processing device, the processing unit of which, for this purpose, may access the corresponding components of the loader program. Preferably, however, at least the corresponding comparison checksum is formed in the loading device which is connected to the processing unit. In this way, manipulation of the checking process, by unauthorized programs which may already be present in the data processing device, is made more difficult.

When generating the comparison checksum, the loading device then uses the same division into memory segments, as well as the same padding data. Preferably, the division and the padding data are specified by the loading device, so that no transfer of this information to the loading device is required. This makes any manipulation still more difficult.

Preferably, the comparison of the checksum with the associated comparison checksum also takes place in the loading device, which is connected to the processing unit. This further increases security because no internal manipulation of the comparison by an unauthorized program that may exist in the data processing device can take place. In this case, the respective checksum is transferred to the loading device, which then compares the checksum with the associated comparison checksum. If the loading device detects that a specific relationship between the checksum and the associated comparison checksum is lacking, for example a lack of consistency, this is signaled in some suitable manner. Additionally or as an alternative, as described above, measures may be taken to prevent the further use of the data processing unit.

In a preferred embodiment of the method according to the invention, in a first sub-step of the loading step, the usable data are made available in an essentially non-compressible form and, preferably, are loaded into the memory device in this form. In a subsequent second sub-step of the loading step, the data are then converted to a compressible form and is then finally loaded into the memory device. Loading the data in an essentially non-compressible form has the advantage that the following manipulation scenario can be prevented: an unauthorized program with a compression function, this program being already present in the memory device, could compress the first data during loading into the memory device so that the data require less memory capacity. In this way, the unauthorized program could prevent itself from being overwritten. Even in the case of variants with the above-described segment-like checking, this might possibly remain undetected in the checking step since, during checking, the unauthorized program might be able to reconstruct the respective data sequence for the corresponding memory segment from the compressed first data, thus pretending that the first memory device has been properly occupied.

In order to bring the data reversibly into such a non-compressible form or an essentially non-compressible form, any suitable algorithms may be used. Generally, data in essentially non-compressible or hardly compressible form is data whose appearance resembles a random data sequence or is at least similar to such a random data sequence. Generally, such a seemingly random data sequence without detectable order or sequence cannot be compressed or can be compressed only to a very limited extent. For this reason it is preferred to use random numbers also for the padding data, as mentioned above. This prevents the use of such a compression attack on the padding data.

Generally, in such a case the above-mentioned unauthorized program does not succeed in compressing the first data or the padding data to such an extent that there would still be enough space for them in the memory device in addition to the unauthorized program. But rather, either a part of the unauthorized program would be overwritten or—if the unauthorized program prevents overwriting—at least parts of the first data or padding data would be lost; a situation which, at the latest, would be detected in the checking step.

In a further embodiment of the method according to the invention, in a first sub-step of the loading step, the usable data are made available in encrypted form and, preferably, written into the memory device. In a subsequent second sub-step of the loading step, the first data are then decrypted and finally loaded into the first memory device. Encryption has the advantage in that the first data, during transfer to the data processing device, are protected from unauthorized access. Furthermore, generally, such encrypted data has an appearance which, depending on the quality of the encryption algorithm, strongly resembles a random data sequence. As a result, such encrypted data are data which, in the sense of the above explanations, are not compressible or not significantly compressible data.

The decryption key for decrypting the data may already be present in the memory device before the data are received in the data processing device. For example, this decryption key can be integrated in the program code of the loader program together with the decryption algorithm. Preferably, a corresponding decryption key for use in decrypting the data is transmitted separately to the processing unit, before the second partial step. This may occur, in particular, by a loading device which is connected to the processing unit.

In this way it is possible to prevent a decryption key, which may have been present for some considerable time in the data processing device, from being compromised in any way before the data are made available, and then being used by an unauthorized program to bypass the above security mechanism using non-compressible data, or hardly compressible data.

Preferably, the decryption key is transmitted only during or after writing the encrypted first data into the first memory device, so as to prevent unauthorized programs from using the decryption key in the described way in order to bypass the above security mechanism using the encrypted and therefore non-compressible, or hardly compressible, data.

Generally, the decryption key is a secret key which is known only to the device which encrypts the data, and, after transmission, is also known to the data processing device. Any known encryption algorithms may be used for encrypting the data. Symmetric encryption algorithms such as DES, Triple DES, RC4 (ARC4), Rijndael, etc. may be considered. It is also possible to use asymmetric encryption algorithms such as RSA etc. In this case, the encrypting device then encrypts either with its private key with the associated public key being transmitted as the decryption key, or, as an alternative, the encrypting device encrypts with a public key which is associated with the data processing device, wherein—in an atypical fashion—the associated private key of the data processing device is then transmitted as the decryption key.

Transmission of the decryption key again may be secured suitable cryptography to ensure that the decryption key is kept secret.

In a preferred embodiment of the method according to the invention, the authenticity of the data is checked in an authentication step which involves the processing unit. This ensures that the data do not contain unauthorized data, in particular unauthorized programs, due to manipulation, for example, during transmission to the data processing device.

To ensure or verify the authenticity of the first data, any known authentication methods may be used. Preferably, cryptography is used for ensuring the authenticity of the first data. For example, message authentication codes (MACS) may be used, as may digital signatures or the like.

The usable data may basically be any type of data. In an embodiment of the method according to the invention, the data represent an executable program. This is particularly advantageous in arrangements in which it must be ensured that the data processing device is to be operated exclusively with the use of authorized programs.

Furthermore, the present invention relates to a data processing device, in particular a microprocessor card, having a processing unit, a memory device connected to the processing unit, and a first interface device connected to the processing unit. The processing unit is designed for loading the usable data, which have been made. available by the interface device, into the memory device by accessing a loader program which is stored in the memory device. For achieving complete memory coverage of the memory device, the processing unit and/or the loader program are designed for complete occupation of the available memory capacity of the memory device during or after loading of the data into the memory device.

With this data processing device, the above-described embodiments and advantages of the method according to the present invention may equally be achieved. For avoiding repetition, reference is thus made to the above information.

Preferably, the first processing unit and, additionally or alternatively, the loader program are/is designed for the above-described filling-up, with padding data, of memory areas of the memory device not being occupied by the loader program or the usable data.

In embodiments of the data processing device according to the invention, the processing unit and, additionally or alternatively, the loader program are/is designed for carrying out a checking step, as described above, for checking the integrity of the data stored in the memory device.

The processing unit and, additionally or alternatively, the loader program are/is designed for the above-described conversion of the usable data, provided in an essentially non-compressible form, to a compressible form and for loading the data in compressible form into the first memory device.

Preferably, the processing unit and, additionally or alternatively, the loader program are/is designed for the above-described decryption of the data, initially provided in encrypted form, and for loading the decrypted data into the memory device.

Further preferably, the processing unit and, additionally or alternatively, the loader program, for carrying out the above-described authentication step, are/is designed for checking the authenticity of the data provided.

The present invention also relates to a data processing device, in particular a microprocessor card, having a processing unit and a memory device, connected to the processing unit, the memory device containing a loader program and usable data. The available memory capacity of the first memory device is completely filled, as explained above in the context of the method according to the invention. With this data processing device as well, the above-described embodiments and advantages of the method according to the invention may be realized to the same extent. For avoiding repetition, reference is thus made to the above information.

In an embodiment of the data processing device according to the invention the memory capacity of the memory device not being occupied by the loader program and the usable data, is occupied in the above-described manner by padding data, in particular, by one or several random numbers.

The data processing device may be designed in any desired way, having a corresponding first processing unit, an interface device, and memory device operating as described above. The data processing unit, for example, may be designed as a pluggable module for any desired data processing device, for example a computer or the like. It may also be designed as a so-called chip card.

The data processing devices according to the invention may particularly advantageously be used in the context of postal franking machines. Preferably, the data processing device for this purpose is designed as a component of a franking machine, in particular, as a security module of the franking machine.

Furthermore, the present invention relates to a loading device, in particular a microprocessor card, wherein the processing unit is a first processing unit and the interface device is a first interface device. This loading device has a second processing unit and a second interface device connected to the second processing unit. The second processing unit is designed for providing the usable data to a data processing device, which is connected to the second processing unit via the second interface device, the data processing device containing the memory device. In this arrangement, the memory device is provided for storing the usable data, representing a loader program. The second processing unit is designed for determining the memory capacity of the memory device that is available apart from the loader program. Furthermore, for achieving complete memory occupation of the memory device, the second processing unit is designed for providing the padding data, the memory capacity available apart from the loader program and the usable data being completely filled in with the padding data.

With this loading device, the above-described embodiments and advantages of the method according to the invention may equally be achieved. For avoiding repetition, reference is thus made to the above information.

In an embodiment of the loading device according to the invention, the second processing unit is designed for carrying out the above-described checking step for checking the integrity of the data stored in the memory device.

Preferably, the second processing unit is designed for providing the usable data in an essentially non-compressible form, as has been described in detail above. Further preferably, the second processing unit is designed for providing the usable data in encrypted form, as also described in detail above.

### DESCRIPTION OF THE DRAWINGS

FIG. 1 Is a block diagram of a preferred embodiment of an arrangement with a data processing device according to the invention, a loading device according to the invention, both serving to implement the method according to the invention.

FIG. 2 is a flowchart of a preferred embodiment of the method according to the invention.

### DESCRIPTION OF THE PREFERRED EMBODIMENTS

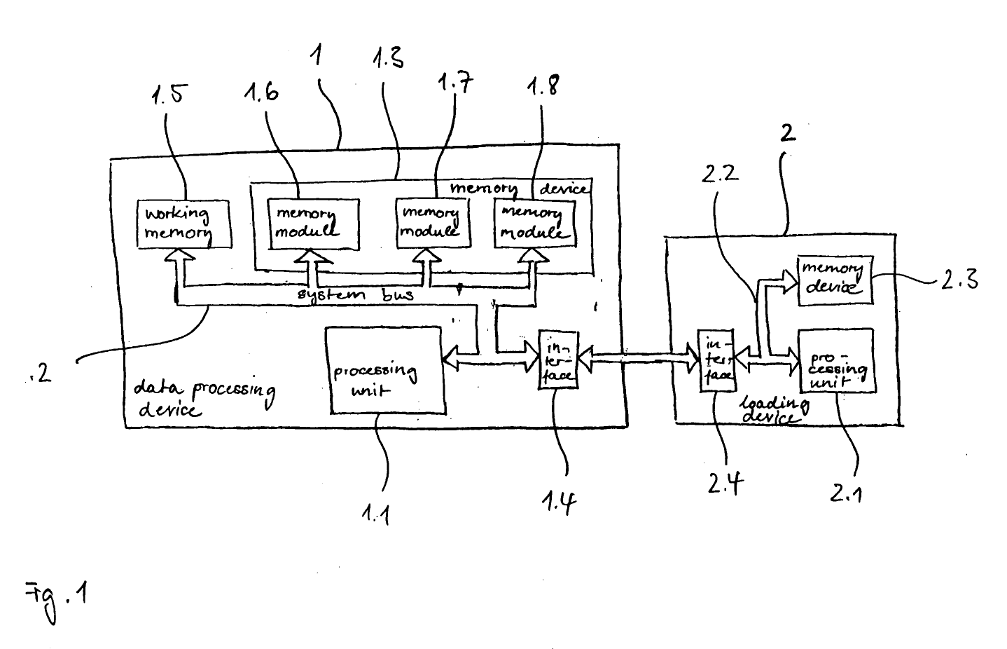

FIG. 1, in the form of a block diagram, illustrates a preferred embodiment of an arrangement having a data processing device 1 according to the invention, and a loading device 2 according to the invention, both serving to implement the method according to the invention.

The data processing device 1 has a processing unit 1.1 connected to a memory device 1.3 via a system bus 1.2. Furthermore, the processing unit 1.1 is connected to an interface device 1.4 as well as to a volatile working memory 1.5 via the system bus 1.2.

The memory device 1.3 provides the non-volatile memory of the data processing device 1. It has three separate memory modules 1.6, 1.7 and 1.8, wherein the memory module 1.6 contains a loader program. The memory module 1.7 and the memory module 1.8 are available for data that are to be loaded into the data processing device 1. This data represent an application program which provides the data processing device 1 with a desired authorized function.

The data are made available by the loading device 2 that is connected to the data processing device 1 via the interface device 1.4. The loading device 2 comprises a second processing unit 2.1 connected to a second memory device 2.3 and a second interface device 2.4 via a second system bus 2.2. In the second memory device 2.3, among other things, the data to be transferred to the data processing device 1 is stored.

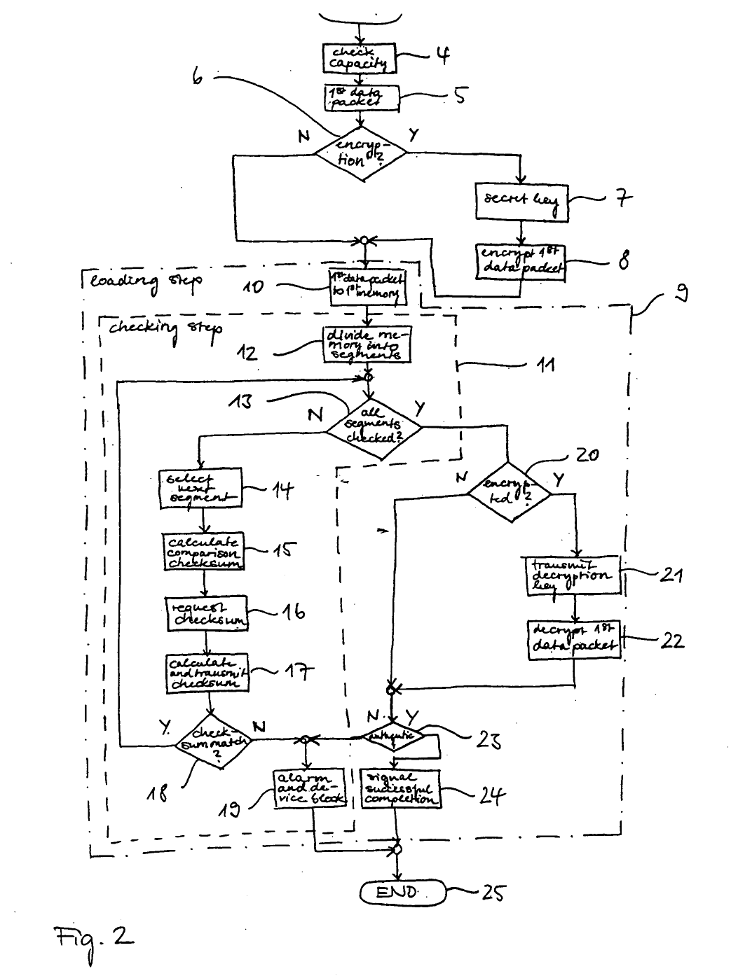

Below, with reference to FIGS. 1 and 2, a preferred embodiment of the method according to the invention is described, this embodiment being implemented with the arrangement having the data processing device 1 and the loading device 2.

At a particular point in time after the connection between the data processing device 1 and the loading device 2 has been established by the interface devices 1.4 and 2.4, the method according to the invention is started in a step 3. This can take place by activating a corresponding input device (not shown in FIG. 1) of the data processing device 1 or of the loading device 2. Likewise, this can take place automatically after the connection between the data processing device 1 and the loading device 2 has been established.

In a step 4, the second processing unit 2.1, by accessing a program stored in the second memory device 2.3, and the data processing device 1 check how much memory capacity, apart from the loader program, is available in the first memory device 1.3.

In a step 5, the second processing unit 2.1 generates a first data packet which contains the first data and the first padding data. In this arrangement, the first padding data contain one or several random numbers, the number and data quantity of which are selected such that the first data and the first padding data exactly fills the memory which is available in the first memory device 1.3, apart from the loader program. The first padding data are generated by the second processing unit 2.1 by accessing an algorithm stored in the second memory device 2.3.

In a step 6, a check is made in the loading device 2 whether the first data are to be transmitted in encrypted form to the data processing device 1. This specification may take place as well by activating a corresponding input device (not shown in FIG. 1) of the data processing device 1 or of the loading device 2. Likewise, this specification can be made automatically, after the connection between the data processing device 1 and the loading device 2 has been made, by polling the state of a memory.

If the check in step 6 shows that the first data are to be transmitted in encrypted form and thus in essentially non-compressible form, the second processing unit 2.1 in step 7 first generates a secret key by accessing a key-generation algorithm stored in the second memory device 2.3.

Subsequently, in step 8, the first data packet containing the first data and the first padding data is encrypted using the secret key. To this effect, the second processing unit 2.1 accesses an encryption algorithm stored in the second memory device 2.3.

In step 8, in certain variants of the method according to the invention, in which compression of the data takes place as part of encryption, furthermore a second data packet is generated, which contains the encrypted first data packet and second padding data. The second padding data again contains one or several random numbers, the number and data quantity of which are selected such that the encrypted first data packet and the second padding data precisely fill in the memory capacity available in the first memory device 1.3 apart from the loader program. Here as well, the second padding data are generated by the second processing unit 2.1 by accessing an algorithm stored in the second memory device 2.3.

It is understood that in other embodiments of the method according to the invention, encryption in which no compression of data takes place can also be provided. In these cases, the length of the encrypted data sequence is then the same as that of the non-encrypted data sequence, as is for example the case in so-called block-by-block encryption. In this case there is no need for generating a second data packet, because the encrypted first data packet, too, is of a size so that in the first memory device 1.3 the available capacity apart from the loader program is filled in by the encrypted first data packet.

In a loading step 9, loading of the first data into the first memory device then takes place such that the loader program, the first data and the first padding data occupy the entire available memory capacity of the first memory device 1.3 so that complete memory coverage of the first memory device 1.3 is achieved.

If encryption with compression was selected, in a first partial step 10 of the loading step 9, by the second data packet, the first data are transmitted in encrypted form and thus in essentially non-compressible form from the loading device 2 to the data processing device 1 and thus are made available to the data processing device 1. In variants of the method according to the invention, in which encryption without data compression is provided, in step 10 the encrypted first data packet with the encrypted first data and the encrypted first padding data are transmitted from the loading device 2 to the data processing device 1 and thus are made available to the data processing device 1. In versions of the method according to the invention in which no encryption was selected, in step 10 the first data packet with the first data and the first padding data are transferred in uncoded text from the loading device 2 to the data processing device 1 and thus are made available to the data processing device 1.

In all three cases, the first processing unit 1.1 writes the data packet in step 10 to the memory areas of the first memory device 1.3 not occupied by the loader program, so that, based on the previously selected data quantity of the corresponding data packet, the entire memory capacity of the first memory device 1.3 is filled in. In other words, complete memory occupying of the first memory device 1.3 is achieved.

In this process, any unauthorized programs or data which may be present in the first memory device 1.3 are overwritten so that in the first memory device 1.3 only authorized data are present. In addition, in versions with transfer of the first data in encrypted form, any compression attack, already been described in detail above, is prevented.

It is understood that in other versions of the method according to the invention, the padding data can be generated by the first processing unit 1.1 by accessing a suitable algorithm, which, for example, may be stored in the code of the loader program.

In a checking step 11, the available memory capacity of the first memory device 1.3 is divided into a number of memory segments, over the content of which a checksum is formed in each case, the checksum then being compared to a corresponding comparison checksum.

In this procedure, in step 12, each of the memory areas of the memory modules 1.6, 1.7 and 1.8 is divided into at least two memory segments. The division is undertaken according to the random principle, in other words according to a suitable random algorithm or pseudo-random algorithm. In the present example this takes place in the second processing unit 2.1, which, for this purpose, accesses a corresponding algorithm in the second memory device 2.3. In other versions of the invention, such division may also be undertaken in the data processing device 1.

In the present example, the comparison as to whether the checksum for the corresponding memory segment corresponds to the associated comparison checksum takes place in the loading device 2. Segment-by-segment checking commences in step 13 in the loading device 2 by polling whether all the memory segments according to the division have already been checked. If this is not the case, in step 14, first the next-following memory segment according to the division is selected.

Subsequently, in step 15, in the loading device 2, first the comparison checksum for the corresponding segment is calculated from the desired contents (first data, padding data, if need be loader program), the desired contents being known to the loading device 2. In versions in which the loader program completely occupies the first memory module 1.6, a corresponding check of the first memory module 1.6 may be omitted, so that the loading device 2 does not have to have any knowledge of the loader program.

In step 16, the loading device 2 requests from the data processing device 1 the checksum for the corresponding memory segment. In step 17, the data processing device generates the checksum for the corresponding memory segment according to the division specified by the loading device 2, and transmits this checksum to the loading device 2. In the present case, the comparison checksum as well as the checksum is generated by the secure hash algorithm SHA-1 as a cryptographic checksum algorithm. To this end, the respective processing unit 1.1 or 2.1 accesses the algorithm stored in the associated memory device 1.3 or 2.3.

In step 18, in the loading device 2, a comparison takes place between the checksum and the comparison checksum for the corresponding memory segment. If they match, continuation is with step 13. If they do not match, in step 19, a corresponding visual and acoustic warning signal is output at the loading device 2. Furthermore, the data processing device 1 is blocked from further operation, and the program sequence is terminated.

It is understood that for generating the comparison checksum and the request, generating and transmitting the checksum in other versions of the method according to the invention, another temporary succession of the steps may be provided. In particular, certain steps also may be carried out in parallel.

If the check in step 13 shows that all memory segments were checked with a positive result, in step 20 there is renewed polling as to whether the first data were transmitted in encrypted form. If this is the case, in step 21, a decryption key is transmitted from the loading device 2 to the data processing device 1, with which decryption key the encrypted first data packet can be decrypted.

In the present example, encryption of the first data packet takes place with a symmetric encryption algorithm (e.g. DES) so that the secret key generated in step 7 is transferred as a decryption key from the loading device 2 to the data processing device 1. The first processing unit 1.1 stores the decryption key in the working memory 1.5.

Subsequently, in a second sub-step 22 of the loading step 9, the first processing unit 1.1 decrypts the first data packet which has been stored in the memory device by accessing the decryption key and the associated algorithm which is integrated in the loader program. The first data packet which has been provided in this way in clear text is then written to the memory area of the first memory device 1.3, which memory area is not occupied by the loader program. By matching the first padding data to the available memory capacity, here as well, complete memory coverage of the first memory device 1.3 with the loader program, the first data and the first padding data is achieved.

In the subsequent authentication step 23, the first data is checked for its authenticity. For this purpose, the first data is given a digital signature which was made over part of the first data. The first processing unit 1.3 verifies this digital signature in order to check the authenticity of the first data.

If the authenticity check has also been successfully completed, in step 24 successful completion of the loading step 9 is signaled by a corresponding visual and acoustic signal issued by the loading device 2. In step 25, the sequence of the routine is then completed. If the authenticity check returns a negative result, then the procedure is as described above in step 19.

In other versions of the method according to the invention, the authenticity check may be omitted. If for the purpose of increasing security the authenticity check is used, then preferably digital signatures based on asymmetric encryption methods are applied in order to avoid the necessity for wide distribution of a secret key. If necessary, be the secret key generated in step 7 also may be used to provide the signature. Moreover, checking the authenticity of the first data also may take place in any other suitable way, for example by using message authentication codes (MACs).

In the present example, the data processing device 1 is the security module of a postal franking machine, while the loading device is a corresponding computer which is connected to the data processing device 1.

In other versions of the invention, the data processing device 1 may be designed and constructed for other desired applications. In particular, both the data processing device 1 and the loading device 2, may be chip cards that are inserted into a corresponding read/write device so as to effect the loading of the first data.

Although modifications and changes may be suggested by those skilled in the art, it is the intention of the inventor to embody within the patent warranted hereon all changes and modifications as reasonably and properly come within the scope of his contribution to the art.

1. A method for loading data into a memory of a data processing device, comprising the steps of:
providing a memory, having a memory capacity, in communication with a processing unit and storing a loader program in said memory; and
controlling entry of data, less than said memory capacity, into said memory with said processing unit in accordance with said loader program, including ensuring complete occupancy of an entirety of said memory capacity during said loading.

2. A method as claimed in claim 1 comprising filling memory areas of said memory not occupied by said loader program or said data with padding data.

3. A method as claimed in claim 2 comprising filling said memory areas with random numbers as said padding data.

4. A method as claimed in claim 3 comprising connecting a loading device to said processing unit and supplying said padding data from said loading device.

5. A method as claimed in claim 1 wherein said memory capacity not occupied by said data and said loading program comprises available memory capacity, and comprising dividing said available memory capacity into to at least two memory segments, each having data content, and, for each of said memory segments, forming a checksum over the data content and comparing said checksum to an associated comparison checksum.

6. A method as claimed in claim 5 wherein the step of dividing said available memory capacity into at least two memory segments comprises dividing said available memory capacity into at least two partially overlapping memory segments.

7. A method as claimed in claim 5 wherein dividing said available memory capacity into at least two memory segments, forming the respective checksums, and comparing the respective checksums to respective associated comparison checksum ensue in a checking step, and comprising repeating said checking step multiple times and, in each checking step repetition, dividing said available memory capacity into said memory segments according to an algorithm and varying said algorithm in each checking step repetition.

8. A method as claimed in claim 5 wherein the step of dividing said available memory capacity into at least two memory segments comprises dividing said available memory capacity into said at least two memory segments according to the random principle.

9. A method as claimed in claim 5 wherein the step of forming a checksum comprises cryptographically forming said checksum.

10. A method as claimed in claim 5 comprising connecting a loading device to said processing unit and forming the respective comparison checksums in said loading device.

11. A method as claimed in claim 5 comprising connecting a loading device to said processing unit and comprising comparing the respective checksums to the respective associated comparison checksums in said loading device.

12. A method as claimed in claim 1 comprising making said data for loading into said memory available in non-compressible form, converting said data in non-compressible form to data in compressible form, and loading said data in compressible form into said memory.

13. A method as claimed in claim 1 comprising making said data for loading into said memory available in encrypted form, decrypting said data in encrypted form to obtain decrypted data, and loading said decrypted data into said memory.

14. A method as claimed in claim 13 comprising transmitting a decryption key for decrypting said encrypted data to said processing unit.

15. A method as claimed in claim 14 comprising connecting a loading device to said processing unit and transmitting said decryption key from said loading device to said processing unit.

16. A method as claimed in claim 1 comprising in said processing unit, checking said data for authenticity.

17. A method as claimed in claim 16 comprising cryptographically providing said data with said authenticity.

18. A method as claimed in claim 17 wherein the step of cryptographically providing said data with said authenticity comprises forming a digital signal over at least a part of said data.

19. A method as claimed in claim 1 wherein the step of loading data into said memory comprises loading data into said memory representing a program executable by said processing unit.

20. A data processing device comprising:
a processing unit;
providing a memory, having a memory capacity, in communication with said processing unit, said memory having a loader program stored therein; and
said processing unit controlling entry of data, less than said memory capacity, into said memory in accordance with said loader program, and ensuring complete occupancy of an entirety of said memory capacity during said loading.

21. A data processing device as claimed in claim 20 wherein said processing unit causes memory areas of said memory not occupied by said loader program or said data to be filled with padding data.

22. A data processing device as claimed in claim 21 wherein said processing unit causes said memory areas to be filled with random numbers as said padding data.

23. A data processing device as claimed in claim 21 wherein said processing unit is adapted for connection to a loading device and receives said padding data from said loading device.

24. A data processing device as claimed in claim 20 wherein at least one of said processing unit and said loader program checks the integrity of said data in said memory.

25. A data processing device as claimed in claim 20 wherein said processing unit receives said data for loading into said memory in non-compressible form, and converts said data in non-compressible form to data in compressible form, and loads said data in compressible form into said memory.

26. A data processing device as claimed in claim 20 wherein said processing unit receives said data for loading into said memory in encrypted form, and decrypts said data in encrypted form to obtain decrypted data, and loads said decrypted data into said memory.

27. A data processing device as claimed in claim 20 wherein said processing unit checks said data for authenticity.

28. A data processing device as claimed in claim 20 wherein said processing unit executes a plurality of routines associated with franking postal items.

29. A data processing device comprising:
a processing unit;
a memory accessible by said processing unit, said memory containing a loader program and data loaded into said memory via said processing unit, said memory having a memory capacity that is greater than said loader program and said data, and said memory capacity of said memory being completely occupied.

30. A data processing device as claimed in claim 29 wherein memory areas of said memory not occupied by said loader program or said data are filled with padding data.

31. A data processing device as claimed in claim 30 wherein said memory areas are filled with random numbers as said padding data.

32. A data processing device as claimed in claim 29 wherein said processing unit executes a plurality of routines associated with franking postal items.

33. A loader device for use with a data processing device having a first processing unit, a memory containing a loader program accessible by said first processing unit, and a first interface providing access to said memory, said loader device comprising:
a second interface compatible with said first interface; and
a second processing unit connected to said second interface for controlling loading of data into said memory, said second processing unit determining an available memory capacity of said memory, not occupied by said data and said loader program, and generating padding data and loading said padding data into said memory via said second interface in said first interface for ensuring complete occupancy of an entirety of a memory capacity of said memory.

34. A loading device as claimed in claim 33 wherein said second processing unit checks the integrity of said data in said memory.

35. A loading device as claimed in claim 33 wherein said second processing unit provides said data in a substantially non-compressible form.

36. A loading device as claimed in claim 33 wherein said second processing unit provides said data in encrypted form.
